(19) United States
(12) Patent Application Publication
(10) Pub. No.: US 2009/0185448 A1
(43) Pub. Date: Jul. 23, 2009

(54) METHOD FOR IMAGING THE EARTH'S SUBSURFACE USING PASSIVE SEISMIC SENSING

(76) Inventors: Peter M. Duncan, Houston, TX (US); James D. Lakings, Houston, TX (US)

Correspondence Address: RICHARD A. FAGIN, P.O. BOX 1247, RICHMOND, TX, 77406-1247, US

(21) Appl. No.: 12/017,010

(22) Filed: Jan. 19, 2008

(51) Int. Cl. G01V 1/36

(52) U.S. Cl. 367/40

(57) ABSTRACT

A method of imaging the Earth's subsurface using passive seismic emission tomography includes detecting seismic signals from within the Earth's subsurface over a time period using an array of seismic sensors, the seismic signals being generated by seismic events within the Earth's subsurface. The method further includes inducing a seismic event within the Earth's subsurface during at least a segment of the time period over which the seismic signals are detected. The method further includes cross-correlating seismic signals detected at each of the seismic sensors to obtain a reflectivity series at a position of each of the seismic sensors.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic imaging of the Earth's subsurface. More specifically, the invention relates to imaging of the Earth's subsurface using passive seismic sensing techniques.

2. Background Art

Passive seismic emission sensing techniques include detecting seismic signals from within the Earth's subsurface. As contrasted with conventional controlled source seismic exploration techniques (wherein a seismic source is actuated near the Earth's surface), in passive seismic sensing, the seismic signals are generated by seismic events taking place within the Earth's subsurface. The subsurface seismic events may be naturally-occurring or may be induced by manmade activities. The seismic signals are detected by an array of seismic sensors positioned at or near the Earth's surface generally above a target volume within the Earth's subsurface. Applications for passive seismic emission tomography include, for example, determining the point of origin of micro-earthquakes caused by movement along geologic faults, i.e., breaks in rock layers or formations, monitoring of fluid movement within the Earth's subsurface, and monitoring of fluid injected into the Earth's subsurface, e.g., in a hydraulic fracturing process or in monitoring movement of a fluid contact in a subsurface reservoir.

In some cases it may be undesirable to use conventional controlled source seismic techniques for evaluating the Earth's subsurface, for example, if a particular area is environmentally sensitive so as to make access and use of seismic sources unsafe or impracticable. There is a need for passive seismic methods that can make 3 dimensional images of the Earth's subsurface similar to those obtained using conventional controlled source seismic exploration techniques.

### SUMMARY OF THE INVENTION

In one aspect, a method of imaging the Earth's subsurface using passive seismic emission tomography includes detecting seismic signals from within the Earth's subsurface over a selected time period using an array of seismic sensors positioned above a target in the Earth's subsurface. The seismic signals are generated by seismic events within the Earth's subsurface. The method further includes inducing a seismic event within the Earth's subsurface during at least a segment of the selected time period over which the seismic signals are detected. The method further includes cross-correlating signals detected by the seismic sensors to obtain a reflectivity series at each of the seismic sensors. The method may include using the reflectivity series at each of the seismic sensors to generate an image of the Earth's subsurface.

Other aspects and advantages of the invention will be apparent from the following description and the appended claims.

### BRIEF DESCRIPTION OF THE DRAWINGS

FIG. 1 shows an arrangement of seismic sensors used in a passive seismic emission technique

FIG. 2 is a flowchart illustrating a method of imaging an Earth's subsurface using passive seismic emission sensing.

### DETAILED DESCRIPTION

The invention will now be described in detail with reference to a few examples, as illustrated in the accompanying drawings. In describing the examples, numerous specific details are set forth in order to provide a thorough understanding of the invention. However, it will be apparent to those skilled in the art that the invention may be practiced without some or all of such specific details. In other instances, well-known features and/or process steps have not been described in detail so as not to unnecessarily obscure the invention. In addition, like or identical reference numerals are used to identify common or similar elements.

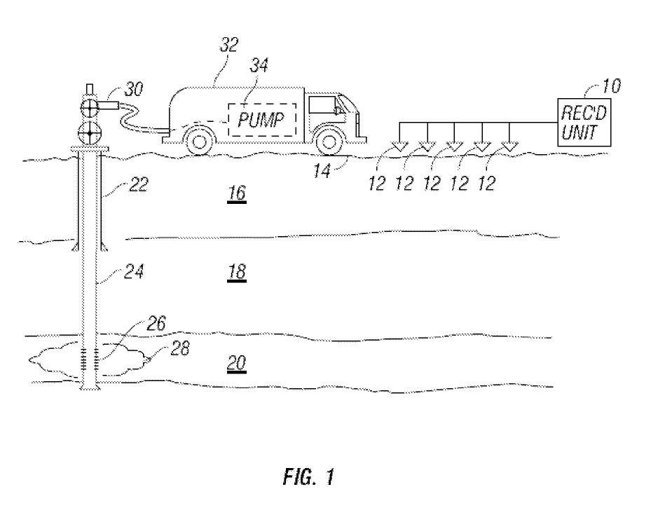

FIG. 1 shows a wellbore 22 drilled through subsurface formations 16, 18, 20. In this example, one of the subsurface formations, shown at 20 can be a hydrocarbon producing formation. A wellbore tubing 24 including perforations 26 for receiving fluid from the hydrocarbon producing formation 20 is deployed in the wellbore 22. The wellbore tubing 24 is connected to a surface wellhead 30 including an assembly of valves (not indicated separately) for controlling fluid flow. The wellhead 30 may be hydraulically connected to a pump 34, which may be a component of a “frac pumping unit” 32. The frac pumping unit 32 may be used to pump fluid down the wellbore 22 and into the subsurface formations, particularly the hydrocarbon producing formation 20, in a well process. i.e., hydraulic fracturing. For illustration purposes, the movement of fluid into the hydrocarbon producing formation 20 is indicated by the fluid front 28. In hydraulic fracturing, the fluid is pumped into the hydrocarbon producing formation 20 at a pressure which exceeds the fracture pressure of the hydrocarbon producing formation 20, causing the hydrocarbon producing formation 20 to rupture and develop fissures. The fracture pressure is generally related to the overburden pressure, i.e., the pressure exerted by the weight of all the formations above the hydrocarbon producing formation. The fluid pumped into the hydrocarbon producing formation 20 may include proppant, i.e., solid particles having a selected size. In propped fracturing operations, the particles of the proppant move into fissures formed in the hydrocarbon producing formation 20 and remain in the fissures after the fluid pressure is reduced below the fracture pressure of the formation, thereby propping the fissures open for subsequent fluid production from the hydrocarbon producing formation. Hydraulic fracturing with proppant has the effect of increasing the effective radius of the wellbore 22 that is in hydraulic communication with the hydrocarbon production formation 20, thus substantially increasing the productive capacity of the wellbore 22.

FIG. 1 shows an array of seismic sensors 12 arranged proximate to the Earth's surface 14 to detect seismic energy from the Earth's subsurface 16, 18, 20. In marine applications, the array of seismic sensors 12 could be arranged at or proximate to the water bottom in a device known as an “ocean bottom cable.” The seismic sensors 12 detect seismic energy created by hydraulic fracturing of the hydrocarbon producing formation 20 as well as other seismic events occurring within the Earth's subsurface. In some examples, the seismic sensors 12 are arranged in sub-groups, with spacing between the sub-groups less than about one-half the expected wavelength of seismic energy from the Earth's subsurface that is intended to be detected. Signals from all the seismic sensors 12 in one or more of the sub-groups may be added or summed to reduce the effects of noise in the detected signals. The seismic sensors 12 generate electrical or optical signals in response to particle motion, velocity or acceleration. A recording unit 10 is coupled to the seismic sensors 12 for making a time-indexed recording of the seismic signals detected by each seismic sensor 12. In some examples the seismic sensors 12 are geophones. In alternate examples, the seismic sensors 12 may be accelerometers or other sensing devices known in the art that are responsive to motion, velocity or acceleration, of the formations proximate to the particular sensor.

In one example, the seismic sensors 12 may be arranged in a radially extending, spoke like pattern, with the center of the pattern disposed approximately about the surface position of the wellbore 22. Alternatively, if the geodetic position of the formations at which the fluid enters from the wellbore is different than the surface geodetic position of the wellbore 22, the sensor pattern may be centered about such geodetic position. Such sensor pattern is used in fracture monitoring services provided under the service mark FRACSTAR, which is a registered service mark of Microseismic, Inc., Houston, Tex., also the assignee of the present invention.

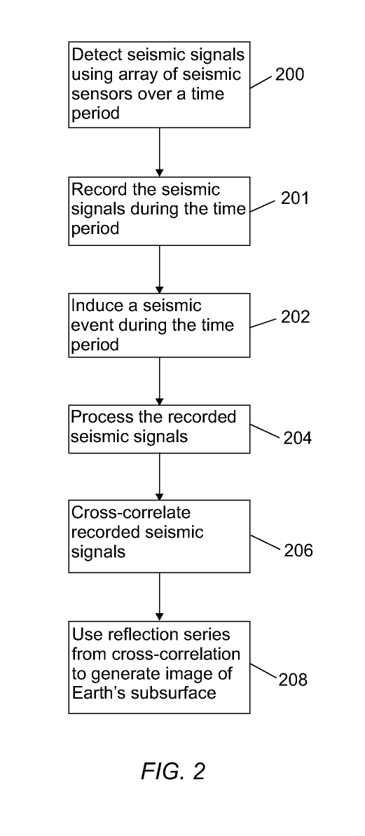

Referring to FIG. 2, a method of imaging the Earth's subsurface includes detecting seismic signals emanating from the Earth's subsurface using an array of seismic sensors (12 in FIG. 1), as shown at 200. The seismic signals, as explained above, are a result of naturally-occurring and/or induced seismic events occurring within the Earth's subsurface. Examples of naturally-occurring seismic events include micro-earthquakes or natural movement of fluid within the Earth's subsurface. Examples of manmade seismic events include fluid movement or formation fracturing resulting from, for example, injection of fluid into the Earth's subsurface, such as during hydraulic fracturing, or production of fluid from the Earth's subsurface as explained above with reference to FIG. 1. Seismic signals detected by the seismic sensors (12 in FIG. 1) are recorded over a selected time period in the recording unit (10 in FIG. 1) as shown at 201. During the selected time period indicated above, at least one manmade activity occurs which induces a seismic event within the Earth's subsurface, as shown at 202. The method thus can include detecting the seismic signals from within the Earth's subsurface before, during, and after the at least one manmade activity.

The recorded seismic signals may be processed by certain procedures well known in the art of seismic data processing, including various forms of filtering, prior to interpretation, shown at 204. In some examples as explained above, the seismic sensors (12 in FIG. 1) are arranged in directions substantially along a direction of propagation of acoustic energy that may be generated by the pumping unit. In FIG. 1, this direction would be radially outward away from the wellhead 30. By such arrangement of the seismic sensors, noise from the pumping unit and similar sources near the wellhead may be attenuated in the seismic signals by frequency-wavenumber (f-k) filtering. Other processing techniques for noise reduction and/or signal enhancement will occur to those of ordinary skill in the art.

Returning again to FIG. 2, at 206 the method includes cross-correlating the recorded seismic signals from each seismic sensor with the recorded seismic signals from each one of a plurality of the other sensors in the sensor arrangement. In some examples, the cross correlation of signals from each seismic sensor may be performed with signals from every one of the other seismic sensors. Cross correlation in the present example may include comparing the entire data record (i.e. over the entire selected time period) from the seismic sensor signal in question to the entire data record from the cross-correlated sensor. The comparing begins with a time offset between compared data records of zero and increments a time offset by a selected time amount (e.g., ¼, ½, or 1 millisecond) for each of a plurality of subsequent comparisons. The time offset may be limited to the expected deepest seismic travel time for the target formations of interest (e.g. three to five seconds). Thus, for each cross-correlated sensor signal, an output of the cross correlation will be a time series beginning at zero time and ending at the time limit.

An amplitude value for each time in the time series will be the degree of similarity of the cross-correlated sensor signal to the sensor signal in question.

In some examples, each sensor signal may be auto-correlated, that is, the signal record may be compared with itself at various values of time delay, just as for the cross-correlation.

The result of the cross-correlation, and the auto-correlation if performed, is a set of traces for each seismic sensor that correspond to seismic signals that would be recorded at such sensor if a seismic energy source were actuated at each one of the cross-correlated sensor locations.

The cross correlations made for each sensor may be processed according to well known techniques for controlled source seismic exploration, including for example, normal moveout correction, and summing or stacking to produce, for each such sensor, a band limited reflectivity series for the Earth's subsurface corresponding to the geodetic position of the sensor under investigation. The reflectivity series represents a record with respect to seismic travel time of reflection coefficients of each of what are inferred as subsurface acoustic impedance boundaries in the Earth's subsurface.

The method then includes using the reflectivity series to generate a two or three-dimensional (3D) image of the Earth's subsurface formation 208. Any suitable 3D seismic image software or tool known in the art may be used to generate the 3D image of the Earth's subsurface formation. Two non-limiting examples of such imaging software include those sold under the trademarks Ω-TIME and Ω-DEPTH, both of which are trademarks of WesternGeco LLC, Houston, Tex.

Seismic imaging techniques according to the various examples of the invention may provide images of the Earth's subsurface without the need to use controlled seismic energy sources such as vibrators or dynamite. By eliminating the need for controlled seismic energy sources, techniques according to the invention may present less environmental hazard than controlled source seismic techniques, and may provide access to seismic exploration where surface topographic conditions make controlled seismic exploration techniques impracticable.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of imaging the Earth's subsurface using passive seismic emissions, comprising:
detecting seismic signals originating from within the Earth's subsurface over a selected time period using an array of seismic sensors deployed proximate the Earth's surface;
inducing a seismic event within the Earth's subsurface during at least a part of the selected time period; and
cross-correlating seismic signals detected at selected ones of the seismic sensors to signals detected at other selected ones of the seismic sensors; and
processing the cross-correlated signals to obtain a reflectivity series at a geodetic position of the selected one of the seismic sensors.

2. The method of claim 1, further comprising generating an image of the Earth's subsurface using the reflectivity series at each of the selected ones of the seismic sensors.

3. The method of claim 1, wherein cross-correlating comprises determining a degree of similarity between an entire signal record of the selected ones of the seismic sensors and an entire signal record of each of the other selected ones of the seismic sensors.

4. The method of claim 1, wherein determining a degree of similarity is performed for a selected range of time offset.

5. The method of claim 1, wherein detecting seismic signals comprises deploying seismic sensors at the Earth's surface.

6. The method of claim 5, wherein deploying the seismic sensors at the Earth's surface comprises deploying the seismic sources in a substantially radial pattern around selected position at the Earth's surface.

7. The method of claim 6 wherein the selected position is at least one of a surface position of a wellbore and a surface position of a fluid exit point from a wellbore into a subsurface formation.

8. The method of claim 1, wherein inducing a seismic event comprises injecting fluid into the Earth's subsurface.

9. The method of claim 8, wherein injecting fluid into the Earth's subsurface comprises hydraulically fracturing the Earth's subsurface.

10. The method of claim 1, wherein inducing a seismic event comprises producing fluid from a formation in the Earth's subsurface.
